(19) United States
(12) Patent Application Publication
(10) Pub. No.: US 2019/0258888 A1
(43) Pub. Date: Aug. 22, 2019

(54) HARDWARE AND SYSTEM OF BOUNDING BOX GENERATION FOR IMAGE PROCESSING PIPELINE

(71) Applicant: HRL Laboratories, LLC, Malibu, CA (US)

(72) Inventors: Austin F. Garrido, Northridge, CA (US); Shankar R. Rao, Norwalk, CA (US); Jose Cruz-Albrecht, Oak Park, CA (US); Timothy J. Derosier, Colorado Springs, CO (US)

(21) Appl. No.: 16/276,076

(22) Filed: Feb. 14, 2019

Related U.S. Application Data
(63) Continuation-in-part of application No. 15/272,247, filed on Sep. 21, 2016, now Pat. No. 10,262,229.
Application No. 15/272,247 is a continuation-in-part of application No. 15/079,899, filed on Mar. 24, 2016.
Application No. 15/272,247 is a continuation-in-part of application No. 15/043,478, filed on Feb. 12, 2016, now Pat. No. 9,721,332.
Application No. 15/043,478 is a continuation-in-part of application No. 15/203,596, filed on Jul. 6, 2016, now Pat. No. 9,998,130.
(60) Provisional application No. 62/221,550, filed on Sep. 21, 2015.
(60) Provisional application No. 62/137,665, filed on Mar. 24, 2015.
(60) Provisional application No. 62/155,355, filed on Apr. 30, 2015.
(60) Provisional application No. 62/221,550, filed on Sep. 21, 2015.
(60) Provisional application No. 62/659,129, filed on Apr. 17, 2018.

(51) Int. Cl. G06K 9/32; G06T 7/187

(52) U.S. Cl. CPC G06K 9/3233; G06T 2207/10016; G06T 7/187

(57) ABSTRACT

Described is a system for bounding box generation. The system operates on an image comprised of pixels having a one-bit value per pixel. Bounding boxes are generated around connected components in the image, the connected components having pixel coordinate and pixel count information. A ranking score is generated for each bounding box based on the pixel coordinate and pixel count information. The bounding boxes are filtered to remove bounding boxes that exceed a predetermined size and pixel count based on the pixel coordinate and pixel count information. The bounding boxes are further filtered to remove bounding boxes that fall below a predetermined ranking score, resulting in remaining bounding boxes. Finally, a device can be controlled or otherwise operated based on the remaining bounding boxes.

### CROSS-REFERENCE TO RELATED APPLICATIONS

The present application is a Continuation-in-Part application of U.S. application Ser. No. 15/272,247, filed on Sep. 21, 2016, which is a non-provisional application of U.S. Provisional Application No. 62/221,550, filed on Sep. 21, 2015, the entirety of which are hereby incorporated by reference.

U.S. application Ser. No. 15/272,247 is a Continuation-in-Part application of U.S. application Ser. No. 15/079,899, filed Mar. 24, 2016, which is a non-provisional application of U.S. Provisional Application No. 62/137,665, filed on Mar. 24, 2015, the entirety of which are hereby incorporated by reference. U.S. application Ser. No. 15/079,899 is ALSO a non-provisional application of U.S. Provisional Application No. 62/155,355, filed on Apr. 30, 2015, the entirety of which are hereby incorporated by reference.

U.S. application Ser. No. 15/272,247 is ALSO a Continuation-in-Part application of U.S. application Ser. No. 15/043,478, filed on Feb. 12, 2016, the entirety of which is hereby incorporated by reference.

U.S. application Ser. No. 15/272,247 is ALSO Continuation-in-Part application of U.S. application Ser. No. 15/203,596, filed on Jul. 6, 2016, which is a non-provisional application of U.S. Provisional Application No. 62/221,550, filed on Sep. 21, 2015.

The present application ALSO claims the benefit of and is a non-provisional patent application of U.S. 62/659,129, filed on Apr. 17, 2018, the entirety of which is hereby incorporated by reference.

### GOVERNMENT RIGHTS

This invention was made with government support under U.S. Government Contract Number HR0011-13-C-0052, entitled, “Revolutionary Analog Probabilistic Inference Devices for Unconventional Processing of Signals for Data Exploitation” (RAPID-UPSIDE). The government has certain rights in the invention.

### BACKGROUND OF INVENTION

### (1) Field of Invention

The present invention relates to an image processing system and, more specifically, to a system for generating bounding boxes in an image for image processing.

### (2) Description of Related Art

Image processing is used for a variety of implementations, including tracking and surveillance applications. In tracking or surveillance, bounding boxes are used to identify an object and, ideally, track that object across image frames and scenery. Bounding boxes can be formed by boxing connected components. For example, the work of Walczyk et al. described performing connected components labeling of a binary image (see, “Comparative Study on Connected Components Labeling Algorithms for Embedded Video Processing Systems” by Robert Walczyk, Alistair Armitage and T. D. Binnie, in Proceedings of the 2010 Intl. Conf on Image Processing, Computer Vision, and Pattern Recognition (IPCV) (CSREA, 2010), the entirety of which is incorporated herein by reference). Although Walczyk et al. disclosed performing connected components labeling, the disclosure was only directed to labeling of the image and failed to further process the boxes or image effectively.

Thus, a continuing need exists for generating bounding boxes while efficiently calculating bounding box coordinates and bounding box object pixel counts to facilitate subsequent ranking and filtering of object boxes for image processing.

### SUMMARY OF INVENTION

This disclosure provides a system bounding box generation. In various aspects, the system includes one or more processors and a memory. The memory has executable instructions, such that upon execution of the instructions, the one or more processors perform several operations, such as receiving an image, the image comprised of pixels having a one-bit value per pixel; generating bounding boxes around connected components in the image, the connected components having pixel coordinate and pixel count information; generating a ranking score for each bounding box based on the pixel coordinate and pixel count information; filtering the bounding boxes to remove bounding boxes that exceed a predetermined size and pixel count based on the pixel coordinate and pixel count information; and filtering the bounding boxes to remove bounding boxes that fall below a predetermined ranking score, resulting in remaining bounding boxes; and controlling a device based on the remaining bounding boxes.

In another aspect, the processor is a field programmable gate array (FPGA).

In yet another aspect, generating the bounding box further includes operations of grouping contiguous pixels in the image; and merging connected pixels as connected components, with the bounding box formed of a box that encompasses the connected components.

Additionally, controlling the device includes causing a video platform to move to maintain at least one of the remaining bounding boxes within a field of view of the video platform.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a system according to various embodiments of the present invention;

FIG. 2 is an illustration of a computer program product embodying an aspect of the present invention;

FIG. 3 is a flowchart illustrating relationships between variables and arrays during preparation according to various embodiments of the present invention;

FIG. 4 is an illustration of a search block used to find pixels labeled values according to various embodiments of the present invention;

FIG. 5 is a flowchart illustrating a search/label process according to various embodiments of the present invention;

FIG. 6A is an illustration depicting a partial image and corresponding labelling according to various embodiments of the present invention;

FIG. 6B is an illustration depicting a partial image and corresponding labelling according to various embodiments of the present invention;

FIG. 6C is an illustration of the full image as partially depicted in FIGS. 6A and 6B, and corresponding labelling according to various embodiments of the present invention;

FIG. 7 is a flowchart illustrating a merge region according to various embodiments of the present invention;

FIG. 8 is a flowchart illustrating state transitions according to various embodiments of the present invention;

FIG. 9A is a flowchart illustrating State 1 according to various embodiments of the present invention;

FIG. 9B is an example of State 2 code according to various embodiments of the present invention;

FIG. 10 is a flowchart illustrating an Incrementer according to various embodiments of the present invention;

FIG. 11 is a flowchart illustrating State 2 according to various embodiments of the present invention;

FIG. 12 is an illustration of a current label module according to various embodiments of the present invention;

FIG. 13 is a flowchart illustrating State 3 according to various embodiments of the present invention;

FIG. 14 is a flowchart illustrating States 4, 5, and 6 according to various embodiments of the present invention;

FIG. 15 is a flowchart illustrating State 7 and a Recall operation according to various embodiments of the present invention;

FIG. 16 is a flowchart illustrating State 7 and a Ranked operation according to various embodiments of the present invention;

FIG. 17 is a flowchart illustrating State 7 and the Ranked operation and Rank module according to various embodiments of the present invention;

FIG. 18 is an illustration depicting an example input image, with one-bit value for each pixel location according to various embodiments of the present invention;

FIG. 19 is an illustration depicting the image with resulting bounding boxes after being passed through the Bounding Box process and filtered according to various embodiments of the present invention; and

FIG. 20 is a block diagram depicting control of a device according to various embodiments.

### DETAILED DESCRIPTION

The present invention relates to an image processing system and, more specifically, to a system for generating bounding boxes in an image for image processing. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a description of the various principal aspects of the present invention is provided. Subsequently, an introduction provides the reader with a general understanding of the present invention. Finally, specific details of various embodiment of the present invention are provided to give an understanding of the specific aspects.

(1) Principal Aspects

Various embodiments of the invention include three “principal” aspects. The first is a system for image processing. The system is typically in the form of a computer system operating software or in the form of a “hard-coded” instruction set or as a field programmable gate array (FGPA). This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

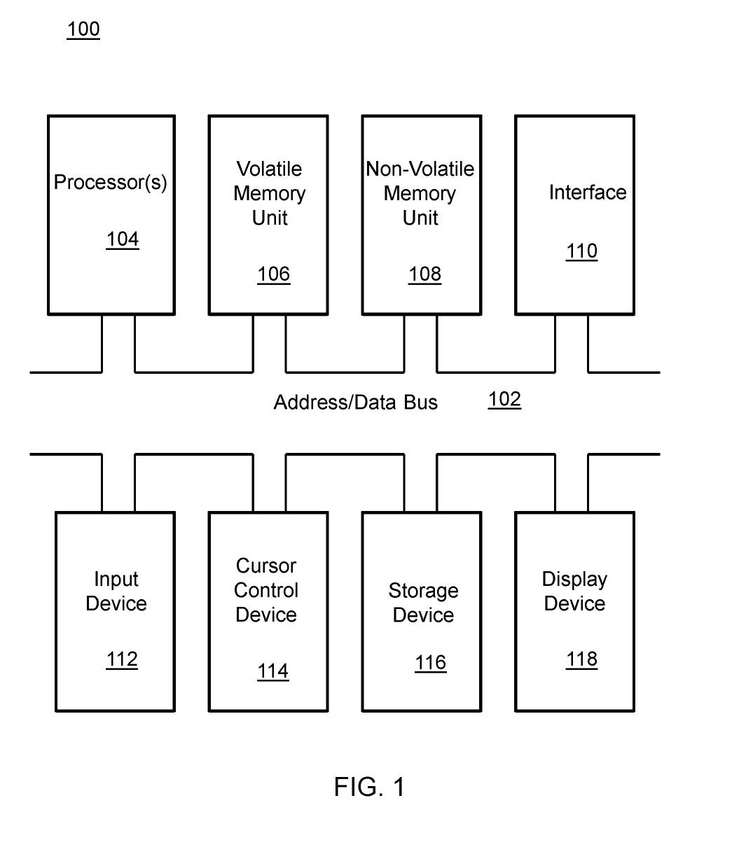

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA) that is configured to perform the operations described herein.

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented.

Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

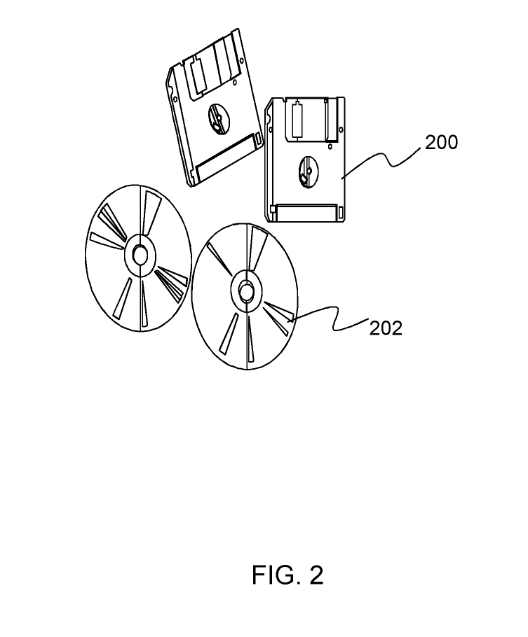

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

(2) Introduction

The present disclosure provides a system and corresponding hardware implementation of bounding box generation for an image processing pipeline. In various aspect, the system is implemented on a Field Programmable Gate Array (FPGA) that receives a binary image from which it detects object pixels and generates bounding boxes around the connected components. The system implements a connected component labeling method for grouping contiguous pixels found throughout the image and afterward merging connecting pixels to create unique boxed locations. These unique boxes are saved as individual units containing the bounding box coordinates and count of contained object pixels. The system also computes, based the height and width of the bounding box and number of contained object pixels, a ranking score used for subsequent filtering of objects based on size and aspect ratio. The process is designed to provide this bounding box information while both minimizing FPGA resources and achieving sufficient throughput to keep up with a desired input image frame rate (e.g., 30 frames per second).

While performing the connected components labeling of the binary image, the system also simultaneously records the bounding box coordinates and the number of detected object pixels for each bounding box. This additional information is useful for subsequent ranking and filtering of objects based on size and aspect ratio, and is gathered without a significant amount of extra computation time and hardware resources. In addition, the design of the invention is optimized to simultaneously minimize FPGA utilization and computation time. The advantages allow the invention to be used as part of a low size, weight and power (SWAP) image processing pipeline (such as that described in U.S. application Ser. No. 15/272,247) that operates at high image frame rates (e.g., >30 frames per second). Using process of the present disclosure would better streamline an image processing pipeline by reducing the amount of necessary calculations over an entire image to specific objects detected.

The system and process as described herein can be implemented as a key component of a low SWAP image processing pipeline. Further, it can be applied to a variety of implementations, including unmanned autonomous vehicles and platforms that have severely limited SWAP. By performing rapid detection of mission-relevant targets and obstacles on hardware near the sensor, the invention is able to improve mission responsiveness and reduce the amount of raw sensor data that must be transmitted over constrained communication bandwidths. In addition, the system and process can be used for both active safety and autonomous driving applications. By performing object detection in a low-power, low-cost hardware near the camera, the automobile can more rapidly and robustly detect obstacles in the road, and thus provide more timely warnings to a driver or more prompt automated responses to obstacles in autonomous vehicles. Further details are provided below.

(3) Specific Details of Various Embodiments

(3.1) Bounding Box Introduction

The bounding box is a method by which the system accepts a matrix of single bit data as an input image, which it uses as a basis to create an array of boxes. Each “box” will contain coordinates for two x locations, two y locations, and a valid pixel count. As an example, one set of box data from the bounding box array would contain x locations, Xmin=100, Xmax=150, and y locations, Ymin=80, Ymax=90, with pixel count=70. This would be a “box” that is 10 pixels tall by 50 pixels wide containing 70 valid pixels. Other sets of pixels are put into boxes and assigned with their own x locations, y locations, and valid pixels count.

What sets each box apart is adjacency and separation from valid pixels. This distinction is further described below with respect to the software and hardware implementations, respectively.

(3.2) Software Bounding Box Design in Matlab

The bounding box process can be implemented using any suitable software product. As an example, the bounding box was implemented in Matlab. The software-based bounding box design can be defined into 3 different sections: Preparation, Search/Label, and Merge Regions. Each section will later be translated to be implemented on the hardware design.

(3.2.1) Preparation

The preparation process is a simple, instantiation and initialization, of the variables and arrays to their defaults values. Variables initialized would be the region count, previous y location, and current y location. Arrays initialized would be the “Image”, “Labeled Image”, “Merge to Region”, and “Bounding Box Data”. Region count will be used as a “ticket” value to label pixels found. Previous/Current Y locations are used as references to decrease the size of the Label Image matrix. A reduced Label Image total size allows a digital circuit to use less hardware resources when implementing the Bounding Box method in such a circuit. Due to the label algorithm search pattern using previous locations, a larger image size must be accommodated by placing extra blank pixels around the image, thereby increasing the size of width and height by 2. Label Image has a height of 2 with a width set to the Image width. The Merge to Region is a single dimension array set to a length of the max region count, which is a set limit to how many labels are maximally desired to be distributed. This limit is to reflect the limited resources used during a digital implementation. The Bounding Box Data is two dimensional having a width of 5 holding: two x locations, two y locations, and a valid pixel count. The Bounding Box Data height is set to the maximum region count.

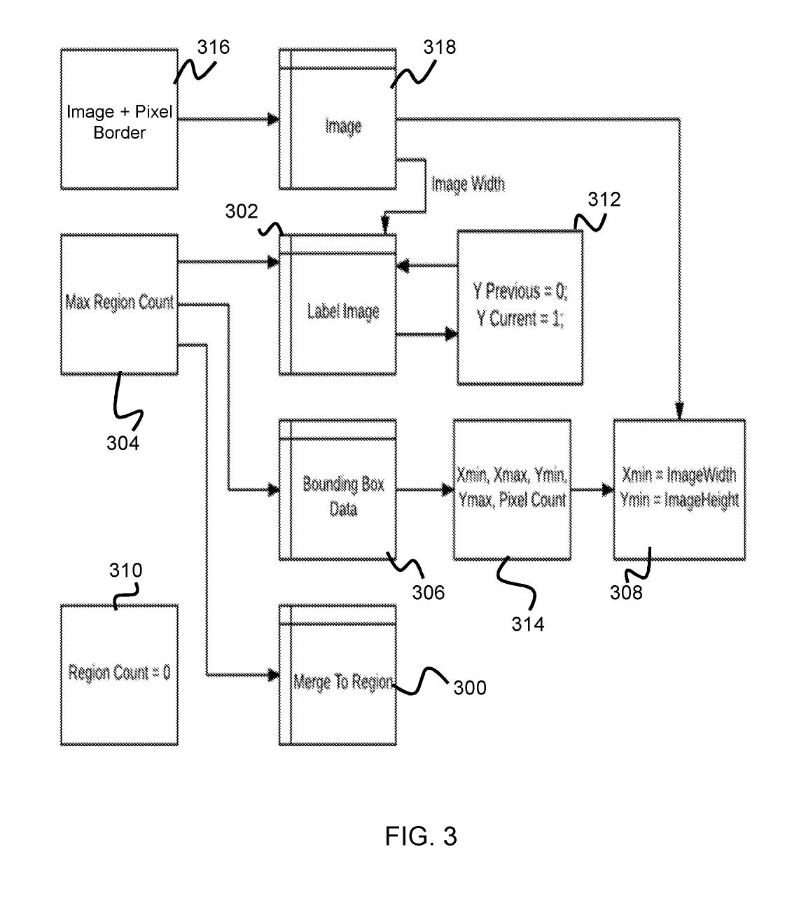

FIG. 3, for example, depicts a relationship between each matrix and variables during their instantiation of the Preparation process. Now that the variables are created, they must be initialized to their correct starting values. For example, the system initiates an array of dimensions image (i.e., size) plus pixel border (i.e., blank pixels which pad the dimensions) 316 for form the image 318. Both Merge To Region 300 and Label Image 302 have all their values initialized to the max region count 304. Label Images 302 proceeds to change 312 the values such that Y Previous is set to 0 and Y Current is set to 1. Bounding Box Data 306 has its minimum x and y values 314 sent to the max size 308 of the Image width and height respectively. Y Previous is set to 1 and Y Current is set to 2. Thus, the values in the matrixes mentioned were initialized to non 0 values. The last thing to initialize is the Region Count 310 which is set to 0. This will keep track of how many labels are generated which will prevent the process from exceeding a max array size.

(3.2.2) Search/Label

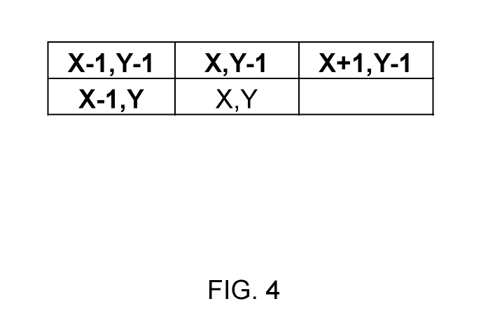

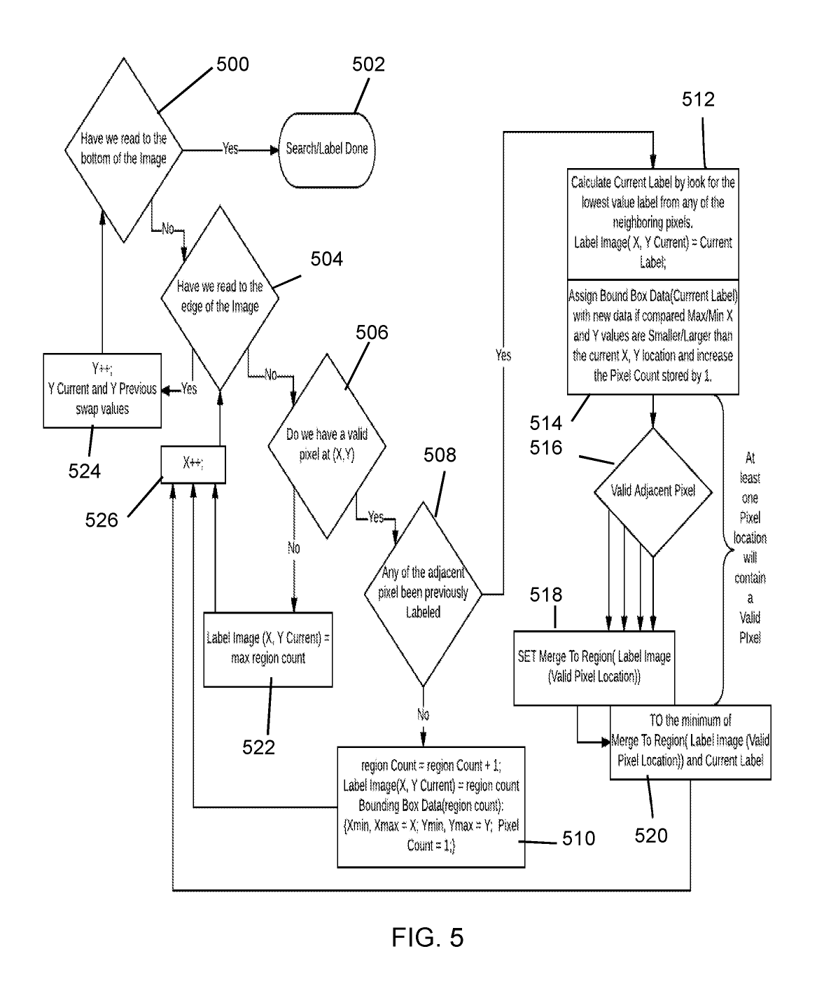

After the Preparation process, the system proceeds with the Search/Label process, as shown in FIG. 5. As the title suggests, the system will search the image and label found pixels (from top to bottom of the image, or any other ordering as predetermined). Pixels are binary in the range of 0 or 1, thereby making something “found” as a pixel having a value. FIG. 4 depicts an example of how the search is conducted. Using the current pixel location in the image as (X,Y), the system first checks to see if (X,Y) has a valid pixel. If so, then the system proceeds to check if (X−1, Y−1)(X, Y−1)(X+1, Y−1) and/or (X−1, Y) have already been labeled. As shown in FIG. 5, the process continues until the image has been searched through 500 (e.g., to its bottom, or top, etc.), at which point the searching/labelling is done 502. Alternatively, assume that this is the first pixel found; thus, no locations currently have a label (e.g., the image has not been read through to its edge 504 and there is a valid pixel at (x,y) 506, and none of the adjacent pixels have been labeled 508). If that is the case, this pixel shall be labelled 508 with the region count of 1 and the region count 510 is increased.

Using the region count, the system will index 510 the Bounding Box Data array storing the pixel count to a value of 1, and use the current x, y locations to store as their min/max values. Since the found box is only one pixel in size, the max and min values for the x and y locations would be equal. Now, assume that the next pixel is also valid. This then creates the condition that (X−1, Y−1), (X, Y−1), (X+1, Y−1) and/or (X−1, Y) has already been labeled. The system then compares each neighbor's label to find the lowest labeled location and refers to that as “Current Label” 512. To do so, the process uses Previous Y and Current Y to index the Label Image; however, using (X−1), (X), (X+1) to move in the other dimension (i.e., in the x dimension instead of the y dimension). Recall that the Label Image array was loaded with the largest value for the region count there by making (X−1, Y Current) the lowest at value of “1” in this example. The value of “1” is then assigned to the label for this pixel. After completing evaluation of one pixel location, the system implements box 526 to increase the “X” index to move closer to the edge of the image. Further after arriving at the edge of the image as seen in box 504, the system begins to implement box 524 which will increase the “Y” dimension and swap the values for Y Current and Y Previous. Remember Y Current and Y Previous are used to maintain a small Label Image Array, hence the Y Current and Y Previous swap will keep the data needed for the next evaluation while opening a new set to be overwritten.

The process then proceeds to determine if the Bounding Box Data is updated by comparing the new data “(X, Y)” with the Max/Min, X and Y values stored. If the stored Max/Min X and Y values are smaller/larger than the new data, then the system will update the Bounding Box Data with the new X and Y locations. Using the above example, the system must update 514 some of the values in the Bounding Box Data by increasing Xmax since the connected pixel increase the box size by 1 in the x direction and the pixel count will increase by 1.

After updating the Bound Box Data, it is noted to later merge unseen pixels since the process may not get a chance to relabel them in the current sweep. This concept will make more sense as described below with a more complicated example. To make a note to merge, first look to identify 516 which neighbors have a valid pixel. Any neighbors that have a valid pixel will check their Merge To Region location 518 compared with the Current Label to find the smallest label. The minimum of the two will then be stored back in their same Merge To Region location 520. In the example, the search is ended by indexing the Merge To Region with the previous pixel location's label and then storing the value of the current label. Lastly, if the current pixel is not valid 522, the Label Image array is indexed by the y Current and x is set to the max value for the regionCount+1.

(3.2.3) Merge Region

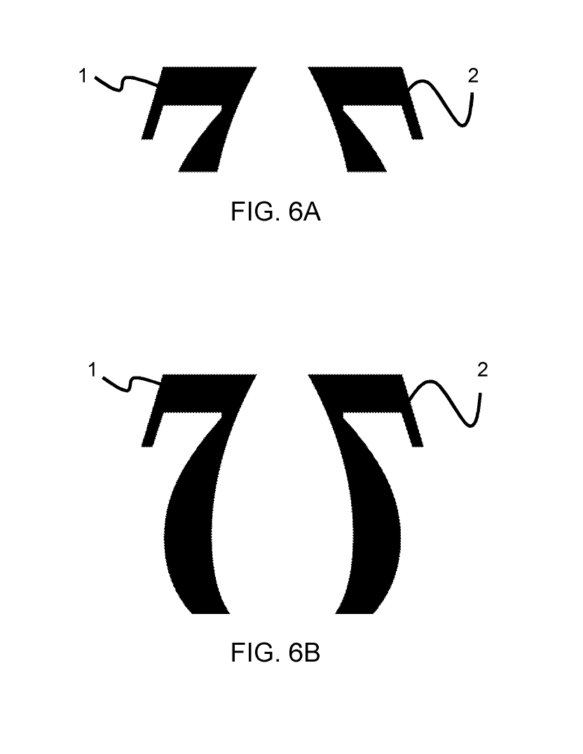

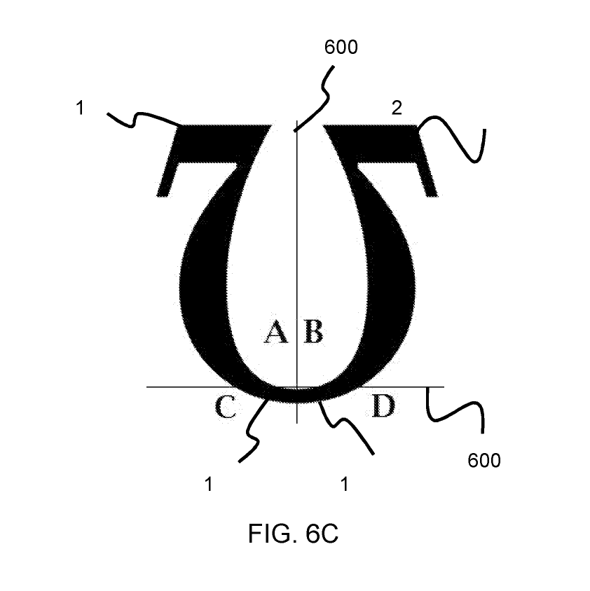

To understand the Merge Region process, it is helpful to view and understand a more complicated Search/Label example. For example, assume that the system is processing the image as shown in FIG. 6C. Given that the system is scanning the pixel image shown in FIG. 6C, the system would “see” the image progressively going from FIG. 6A to FIG. 6B to FIG. 6C. Notice that in FIGS. 6A and 6B, the images contain separate components during the scan such that one would not know that the two separate components were connected. That being the case, it is assumed as an example the left side has a label 1 while the right side has a label 2. Only when a pixel bridges between the two sides is it known that these are part of the same image and should be labeled accordingly; however the system/process is not able to change the information found in label 2 since at this point it is unknown if and how many components are connected. To solve this issue, the Merge To Region array sets location 2 with a value of 1. Later, this change will be used to convert all labeled locations of 2 to be that of 1.

In the full image and as shown in FIG. 6C, lines 600 can be used to cut or otherwise divide the image, showing that A and C would contain all those components labeled as 1 in this example. B would contain all those components labeled as 2 and still labeled as 2 in this example. D would contain all those components that would have been labeled as 2 but are instead now labeled as 1.

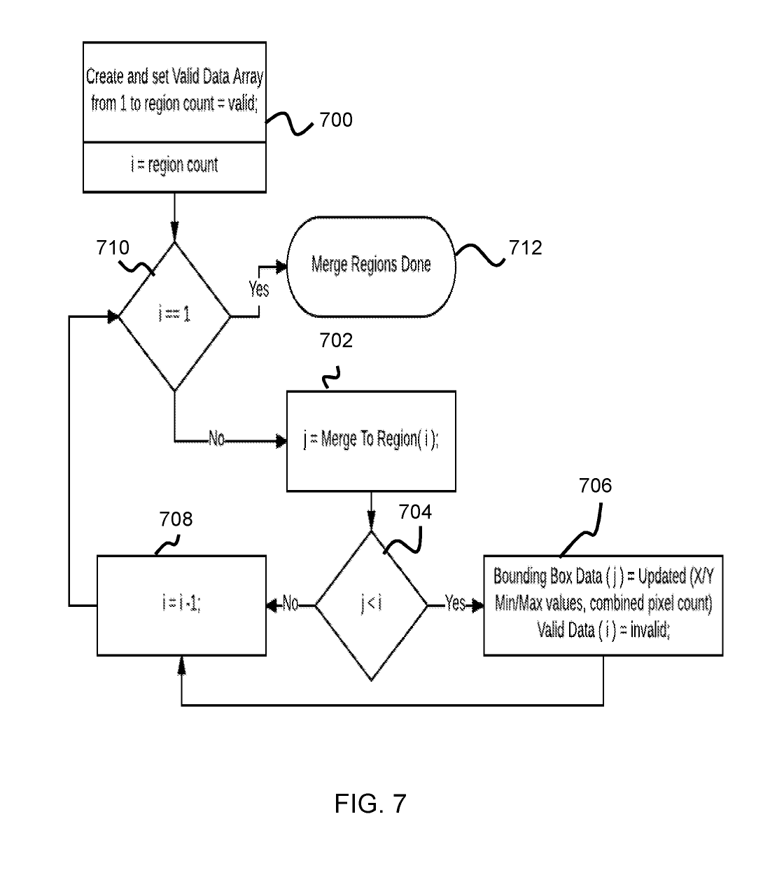

The last step is the Merge Regions process, as shown in FIG. 7. In this step, reminders to update as found in the Merge To Region array are placed into the appropriate bounding boxes. Before the section starts, a new array is created 700 which will keep track of the valid Bounding Box Data. The valid data array will start with everything as “true” up to the region count and anything above as “false” up to the max region count (with the same length as the Bounding Box Data). The stored Bounding Box Data values may be merged into a central location leaving one or more sets of data invalid. Since it is known that the labels are given out from smaller to larger numbers, the system starts by retracing the Bounding Box Data from the current region count (previously used to count how many labels were given out), counting down to 1 in a for loop. A for loop is a process that is repeated in a loop until its finished. There are different types of these loops but typically a for loop preforms some action until it hits an ending condition. Usually in the loop you are either counting down or up to reach the condition to end your process and leave the loop.

The necessity to update is determined by looking at the current index of the for loop and comparing that with the Merge To Region 702 indexed by that same value. The Merge To Region 702 array would have been updated 704 to a lower value then the index if at some time during the Search/Label phase a connection was found to a different, smaller label. If this never happened, then the Merge To Region will naturally have a larger number from the original Preparation phase. Thereby, if the index of the for loop is greater than the information stored in Merge To Region of that same index, then the system needs to update 706 the Bounding Box Data to include to newly found information. The Bounding Box Data will contain the Xmin, Ymin, Xmax, Ymax, and pixel count information; therefore, to update 706, the process proceeds to look at the Bounding Box Data in two indexed locations (i.e., (1) that of the current index and (2) that of the value stored in Merge To Region of that same index). Using these two locations; the min values are compared to see which has a smaller value, the max values are compared to see which has a larger value, and the pixel count values are combined. The information is then stored back into the Bounding Box Data indexed by the Merge To Region value indexed by the for loop which will contain the lower label. Once the array reaches that lower index 708, the Bounding Box Data is fully updated in that location with the most current information on min, max, and pixel count values. This process is repeated until there is a region count of one 710, which is the lowest label and it is not possible to have another location to merge into. At this point, the Merge Regions process terminates 712. The output would now be the values stored as the Bounding Box Data along with the validation array, which identifies which parts of the Bounding Box Data contains boxes with regions that have been unmerged or have the most up-to-date merged information.

(3.3) Hardware Bounding Box Implementation

As noted above, the present disclosure also provides a digital hardware implementation for generating the bounding box. Creating the digital hardware implementation requires reducing the bounding box to some known range of values. For illustrative purposes, the implementation is described with respect to an image being 512 pixels wide by 256 pixels long, with each pixel containing a one-bit value. The design is to be controlled from an outside module such that the bounding box module will receive a start signal and will need to be allowed to index the necessary image locations per request. To meet other specifications on an image processing design, additional filtering was also implemented and the provided results were reduced to the top 15 ranked boxes. All bounding boxes are found and stored in memory; however, the module will provide specifically 15 which are ranked in a manner as described in further detail below.

Just like in the software design, the hardware can be summarized into three stages, that of Preparation, Search/Label, and Merge Regions. However, in this hardware implementation, there is one additional stage referred to as Recall and Rank. The translation in the hardware also requires that functions finish in a certain clock cycle. That being the case, the algorithm has been broken up into different states. Also, to reduce hardware strain on the use of many flip flops, the large Bounding Box array is stored in block random access memory (BRAM). The Flip flops are a type of registers which stores bits. They are found in the fabric of the FPGA, and to reduce the amount required to store the created data, they are placed into BRAM (which is another component in the FPGA). This further requires that the algorithm be broken up into states, some of which are used to hide indexing and receiving information from the BRAM.

(3.3.1) Preparation

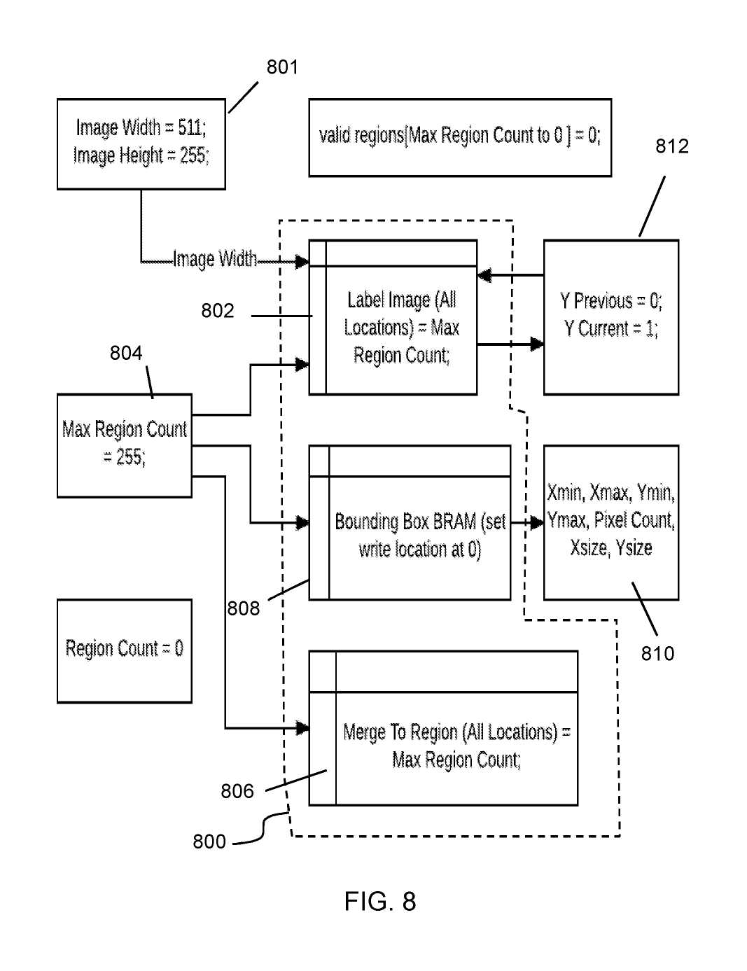

The hardware Preparation section translates to both the instantiation and some of the initialization of the variables needed in the algorithms. As discussed before and as shown in FIG. 8, the limitation of hardware requires the sizes of the variables to be labelled. The process is illustrated in FIG. 8, in which some boxes represent an array 800 while the remaining boxes each represent a value. The largest limitation is that of the amount of labels that can be provided. In one example, the number of labels was reduced to 256, which in turn will set the range of many of the arrays. Just as before, a Label Image array 802 is included for an input image 801, which, in this example, will be 255 dimensions tall and 511 (width of the image) (dimensions) wide. The data contained will have a max region count 804 as large as 255, meaning a size of 8 bits to represent those ranges. Merge To Region 806 will be 256 wide with values as large as 255, meaning a size of 8 bits. As a rule of thumb, anything regarding the width will be as large as 511, requiring 9 bits, and the height will be as large as 255, requiring 8 bits. Pixels presented to use are 1 bit wide. Since the size of the BRAM 808 is as long as the maximum label, which is 256, the write and read addresses would then be 8 bits wide. The BRAM will contain all the information 810 from the Bounding Box BRAM array 808. As in the software case above, the information 810 contained will be that of Xmax, Ymax, Xmin, Ymin, and Pixel Count. However, in addition to that, the hardware implementation includes Xsize and Ysize which is a simple (Xmax−Xmin or Ymax−Ymin) calculation.

Just as in the software, all of the variables must be initialized. The variables can be initialized in the reset and state 0. In reset, all the values in Label Image and Merge To Region 806 are set to 255, which would be the largest valued label, setting all other values to 0. Bounding Box BRAM 808 will not be set to any value since it is unknown what is contained in the BRAM. Instead, it is desirable to keep track of where the write pointer is to know which section of the BRAM is valid. In state 0 812, when given the start command, the Label Image and Merge To Region values are set to 255, the state to 1, Y Previous to 0, Y Current to 1, with all other values set to 0. As a reminder the digital implementation starts at 0 to index the first row rather than 1, which was done previously in the software implementation.

(3.3.2) Search/Label

Following along with the software is the Search/Label section. Since the Bounding Box is in BRAM, the search/label functionality is split to allow for reads to BRAM. Given that constraint, the Search/Label software design can be further separated into different sections of the states to take advantage of the clock delays. Therefore, the Search/Label is broken up into three states with a special incrementer stage.

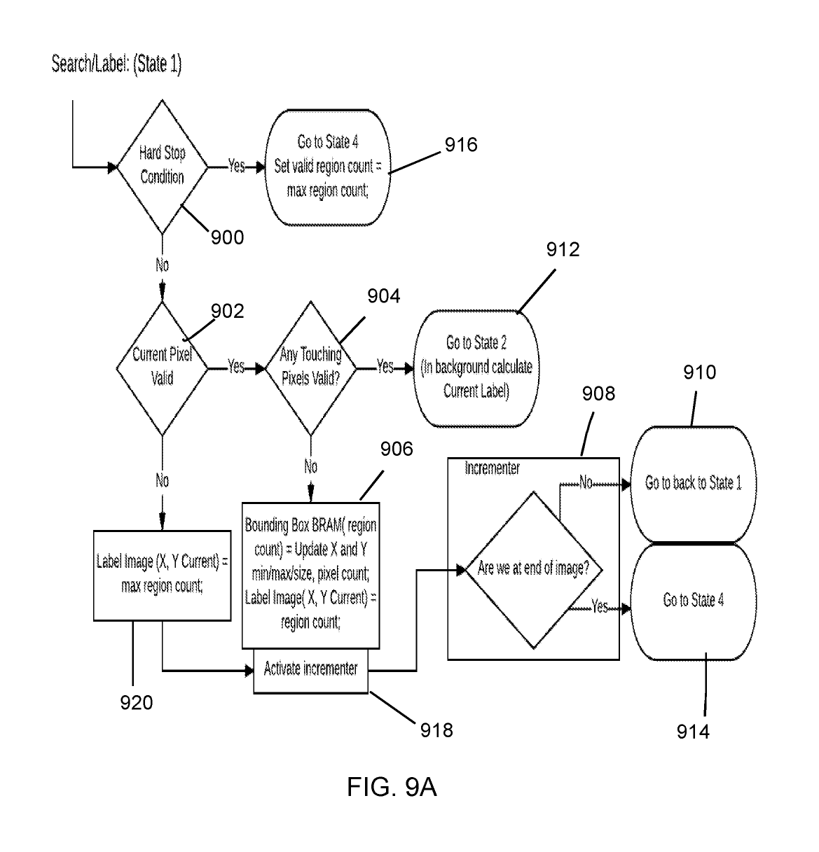

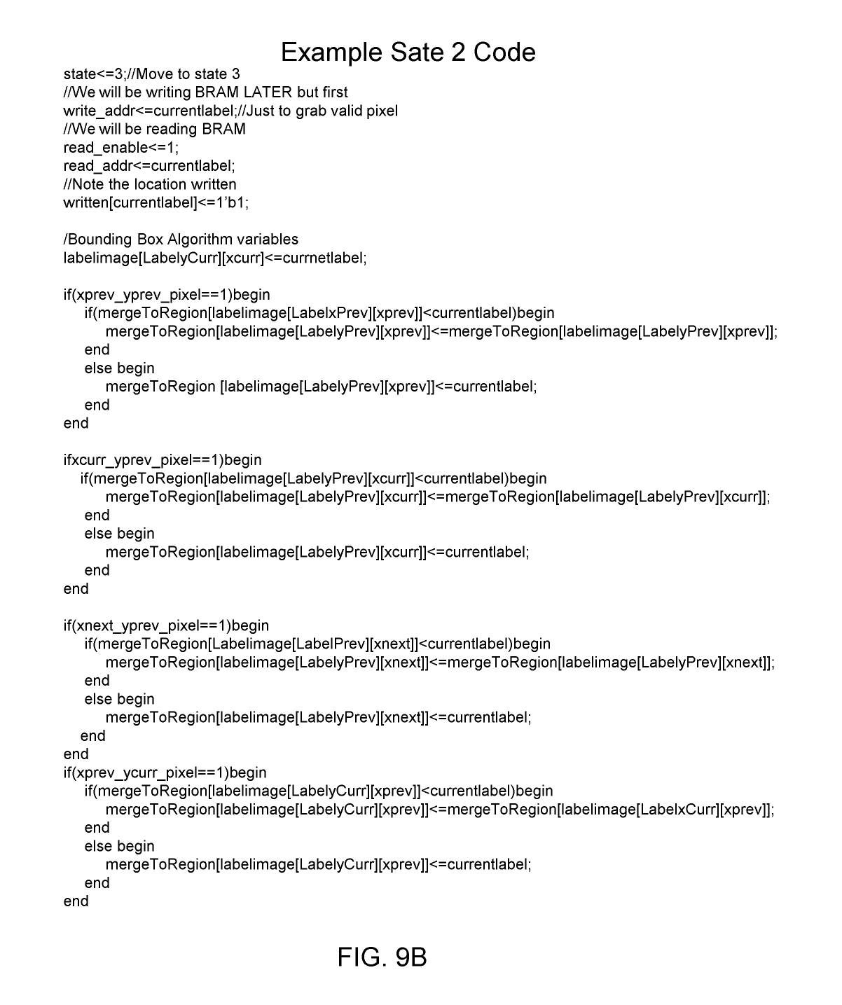

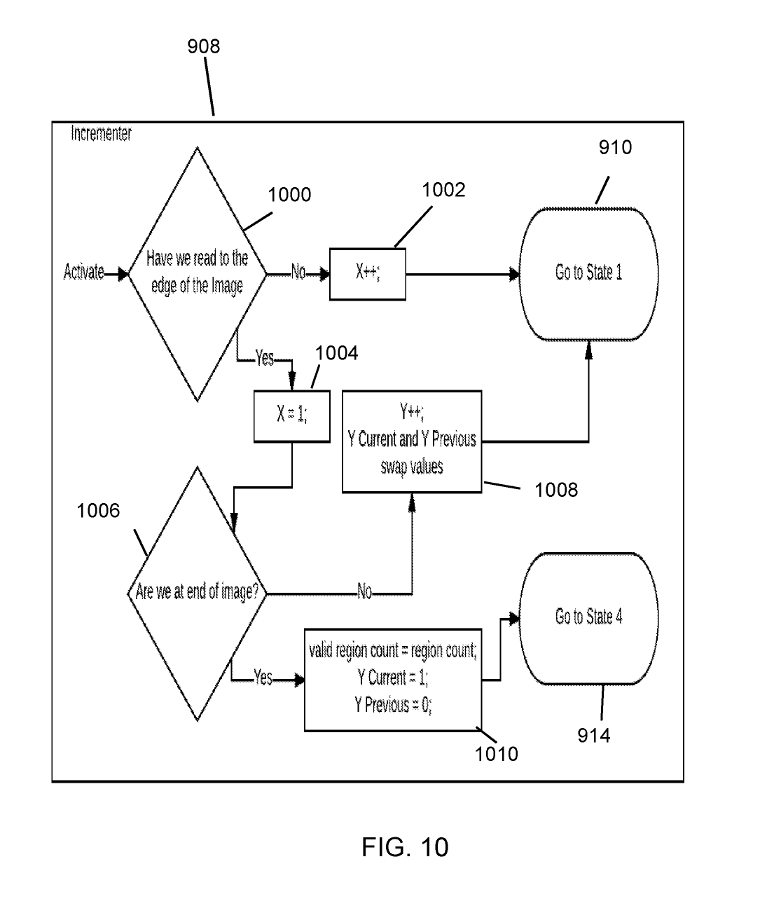

As shown in FIGS. 9A and 10, State 1 will contain the condition for finding a new pixel or finding no pixel at a current search location. If no hard stop conditions exist 900, and if a current valid pixel is found 902, it is desirable to determine if any of the pixel's neighbors (as seen in FIG. 4) 904 have valid pixels. If none of the neighbors have a valid pixel, then the Label Image Array and the Bounding Box BRAM are updated 906 and the incrementer 908 is activated 918. The write command to Bounding Box BRAM will take one clock cycle, but since the process increments (via the incrementer 908) the write address to never re-write an area in BRAM and state 1 does not read the BRAM, the process can return back to state 1 910 without any issue, thereby not needing unnecessary wait states. For further understanding, the FPGA/Hardware is made up of processes running in parallel every clock cycle and will confirm actions at the end of every clock cycle. It should also be noted that the BRAM operates with some clock cycle delays. The BRAM is a place the system will write to and read from. Given that the FPGA is confirming actions at the end of the clock cycles and that there are delays in BRAM, it is desirable to not improperly access the BRAM before a write operation is finished. In other words, the system is not attempting to read a location that is currently being written to and, instead, should only read a location once the write delays are over. It should also be noted that State 1 does not re-write locations or need to read, it writes only under the condition that the process returns to State 1 910. This will hide the write clock cycles so that the BRAM is ready and there is no need to add wait clocks to this state.

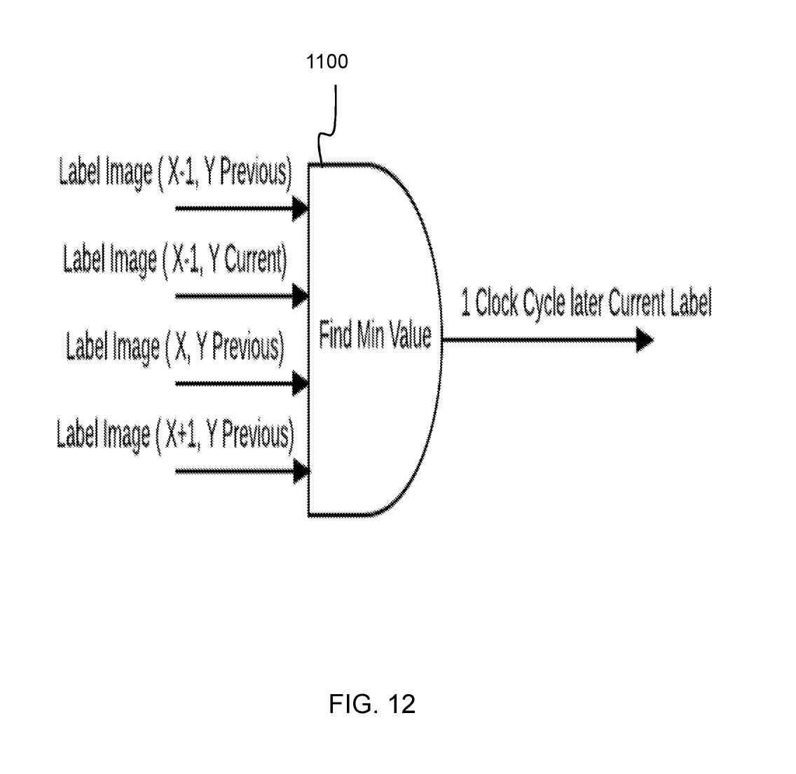

If there was a valid pixel in the neighboring pixels 904, then move to state 2 912. Unique to the digital implementation is a function for a hard stop 900 and incremeter 908. The incremeter 908 will act as a for loop, moving the current pixel and requesting the next set of pixel values. Once the whole image is read, the incremeter 908 will move the state machine into state 4 914 to begin the Merge Regions section. However, because there is a chance of overflowing by giving too many labels, State 1 implements a hard stop 900 looking to see when the process is one less than the max label range. If this is found, then there is no need to keep searching the image and, instead, the process proceeds to state 4 916 to begin the Merge Regions section. If the system has not hit a hard stop and has not found a valid pixel then 920 Label Image must reset the data stored at that pixel location to the max region count. This will ensure that when the system compares Label Image locations (see in FIG. 12) that the lowest location is up-to-date and contains only valid data relating to that section of the image.

Further, FIG. 10 illustrates the incrementer 908 process, showing the decision between proceeding to State 1 910 or State 4 914. After activation of the incrementer 908, if the process has not read to the edge of the image 1000, then the system increments the “X” index to move closer to the edge of the image 1002 and proceeds to State 1 910. Alternatively, if the process has read to the edge of the image 1000, then resets the “X” index to 1 1004, and determines if the process is at the end of the image 1006. If not, then increments the “Y” index to move closer to the end of the image and swaps the values for “Y Current” and “Y Previous” 1008 and proceed to State 1 910. Alternatively, if so, then reset “Y Current” and “Y Previous” to their starting values and locks in the valid region count to the current value of the region count 1010 and proceed to State 4 914.

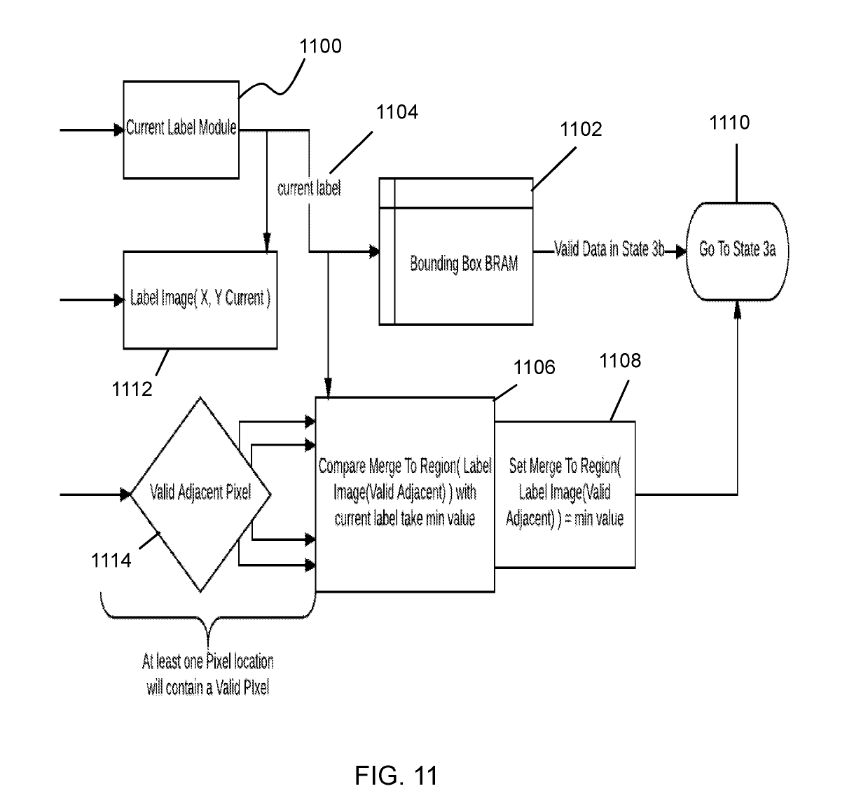

As shown in FIG. 11, State 2 uses another module referred to as the Current Label Module 1100, shown in further detail in FIG. 12. Here, the clock cycle delay is used to perform the current label assignment 1112 in preparation for this stage (note discussion above regarding FPGA clock cycles and BRAM read/write delays). Referring again to FIG. 11, because the Bounding Box BRAM 1102 will take one clock cycle to read, it is necessary to send a read signal along with the current label 1104 to read the address which contains the data to be combined. BRAM needs a signal to indicate that the process is going to read, along with an address. “Current label” 1102 will be the read address. Note the comments above regarding “Search/Label” section functions, where here the system is combining labels to later be merged.

State 2 will contain only the section on which to set the Merge To Region. State 2 exists to set the “Merge To Region” 1108 array with data which will later be used in State 3a 1110 and during the “Merge Region” phase.

Just like in the software aspect, current label 1104 is compared 1106 along with what is stored in the Merge To Region to update based on a valid adjacent pixel 1114, to which the system will compare values found inside the “Merge To Region” array to the lowest label value. The lower “valued” label will be the value stored into the “Merge To Region” array. Because the labels are provided in consecutive order, the lower label should be the reference later used in the Merge Regions section. See FIG. 9B for example State 2 code and FIG. 12 for an illustration of the Current Label Module 1102.

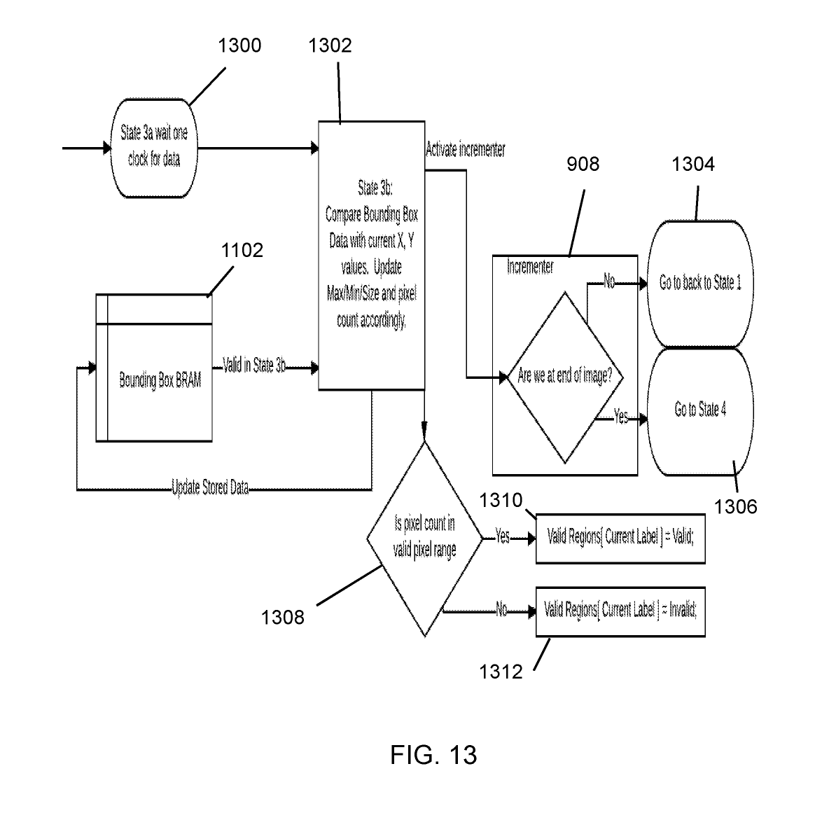

State 3, shown in FIG. 13, covers the last parts of the Search/Label phase. In State 3, the Bounding Box BRAM 1102 is updated. However, because a read was sent in State 2, this data only becomes valid after one clock cycle. Therefore, refer to State 3 as two parts. State 3A 1300 which will wait one clock cycle for valid data from BRAM 1102 and State 3B 1302 will then update the Bounding Box BRAM 1102. Assuming that the data is received in the second cycle, the update to the Bounding Box BRAM 1102 can be performed. The updated includes combining the data read out from the calculated current label location with the current information. Just as in the software, it is desirable to compare the max and min values of x and y locations and set whichever is larger and smaller back into the Bounding Box BRAM 1102. It is also desirably to increase the pixel count to one larger for the new pixel found. The digital implementation also adds another section to calculate the size for both the X and Y direction. This will later be used as a filter for unwanted bounding boxes. Another addition is to filter out unwanted boxes that do not meet a certain range of pixel size 1308. A lower bound and upper bound pixel count is applied to validate Bounding Box BRAM 1102 stores (with pixel counts being in a valid pixel range designated as valid 1310, while pixel counts outside the valid pixel range are designated as invalid 1312). Thus, the valid regions array is used to determine what information stored in BRAM should be tested in a later stage by assigning value of “1” to addresses which house valid sets of data. The valid regions array will later be cycled through to see if the system should read data stored in BRAM from that address location during the Recall and Rank phase. Finally, the system activates the incrementer 908 and sends the process 1304 to State 1. However, if the incrementer 908 detects that the process is on the last pixel location it will instead send the process 1306 back to State 4 as seen in FIG. 10.

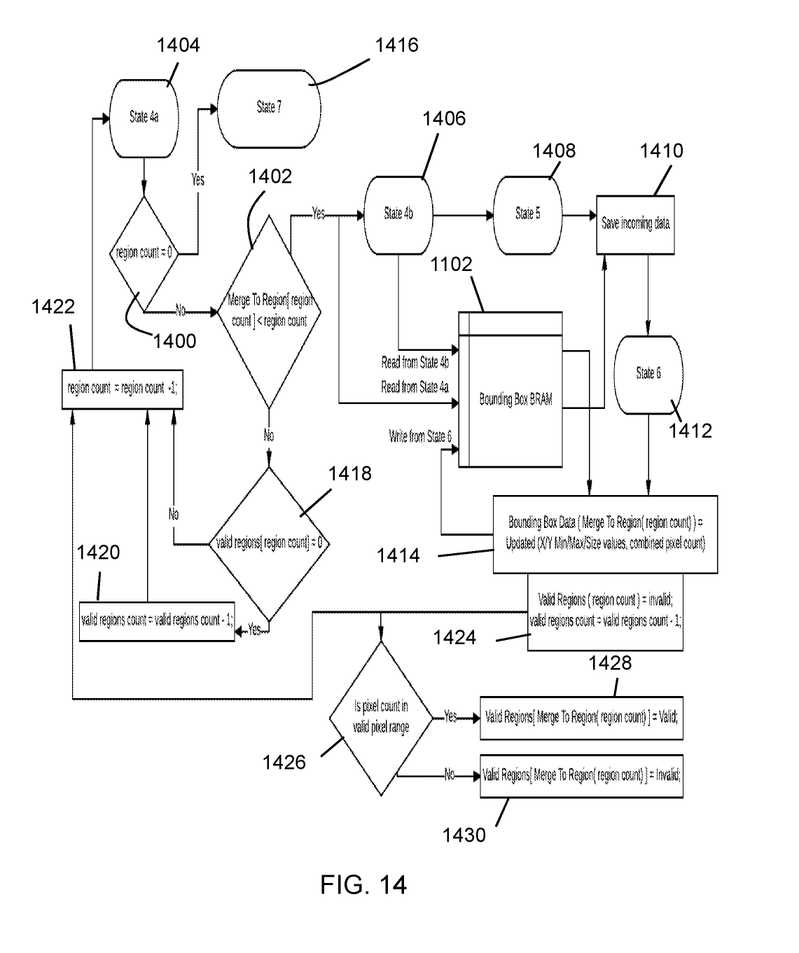

As shown in FIG. 14, States 4, 5 and 6 cover the Merge Regions phase. In State 4, the system searches through the Merge To Region 1402 starting with the region count 1400 then counting down to determine if it needs to merge data. If so, then two addresses are needed, (region count 1400 and Merge To Region[region count] 1402) from the Bounding Box BRAM 1102 and the system writes back to the Bounding Box BRAM 1002 location. If not, the system continues searching through the Merge To Region by decreasing region count 1422 and decreasing the valid regions count 1420 based on data created during state 6 1426 1430 eventually implemented by 1418.

Due to the BRAM 1102 reads, the process must return to State 4 to cover one clock cycle delay of reading and to request a different address. For clarity, State 4 is broken into two parts, State 4a 1404 to determine if there is a need to merge and State 4b 1406, which includes the clock cycle wait and read next address.

State 5 1408 is very simple since it is known that BRAM 1102 has valid data from State 4a 1404. Thus, data that has arrived must be saved 1410 so that the data can later be used to compare against the address read in State 4b 1406.

State 6 1412 will then compare 1414 both sets of data received from the two Bounding Box BRAM 1102 reads then store the merged information back accordingly into the Bounding Box BRAM 1102 with the lower address. Since the write will take place during State 4a 1404, the system will have correctly written before activating the read of the next address. Arriving in state 6 indicates that the current region count is going to be merged, thereby the system will invalidate that region for the valid region array and decrease the valid region count 1424. As was the case above, a filter can be added to filter out regions (unwanted boxes) that do not meet a certain range of pixel count 1426, with pixel counts being in a valid pixel range designated as valid 1428, while pixel counts outside the valid pixel range are designated as invalid 1430.

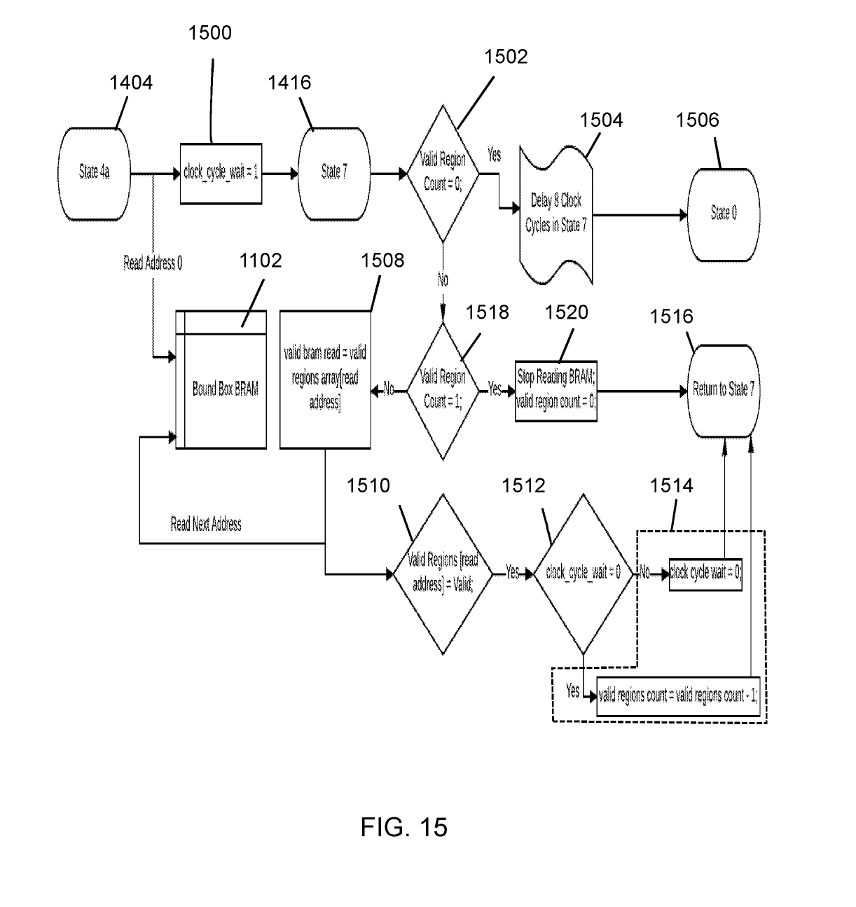

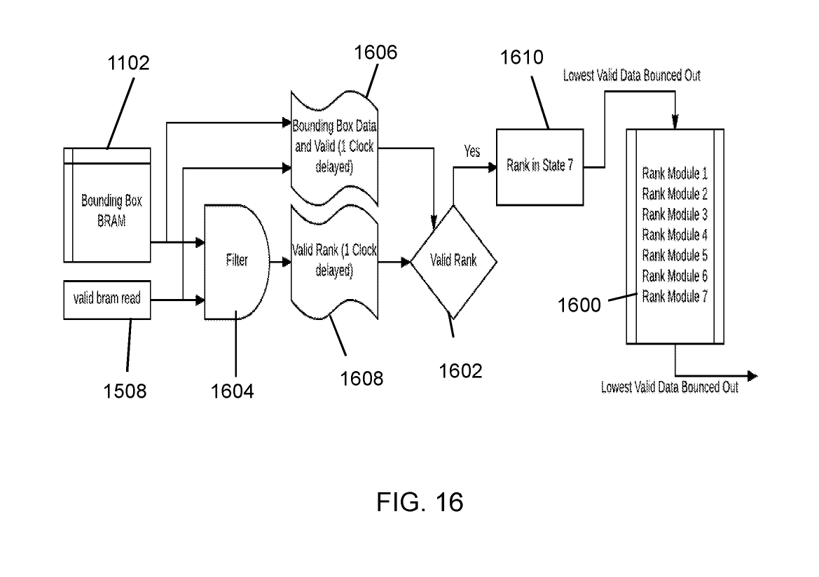

Unique to the implementation is the addition Recall and Rank phase carried by State 7 1416. Specifically and as shown in FIGS. 15 and 16, the State 7 focuses on both recall and ranked operations, respectively. As shown in the recall operation of FIG. 15, this phase will recall all the valid information from BRAM 1102 until the process has read out all valid regions that have been stored.

From previous states, the process has been counting how many locations in the Bounding Box BRAM 1102 that are valid after filtering, and tracking addresses with a valid array. Therefore, to recall all valid locations, the valid array is used to check if the area in BRAM 1102 has valid data and then the valid data count is decremented. BRAM has two clock cycles of delay when reading. Moving from State 4a to State 7 is handled by starting a read 1508 from BRAM as a valid region 1510 at address zero 1512 and by forcing one clock cycle wait 1514 before returning to State 7 1516. The idea is to constantly read addresses from the Bounding Box BRAM 1102 such that the process is just one clock cycle behind 1500 each read. State 7 1416 will filter based on if the read from Bounding Box BRAM 1102 is valid 1502 and meets additional filtering. Delaying clock cycles are included in 1504 before returning to State 0 1506 to account for the additional filtering delay. Box 1518 depicts the end of the search for valid regions, thereby the system must be forced to stop the constant reading of addresses seen in 1520.

During State 3 and State 6, a pixel count valid range was used as the initial condition for validating Bounding Box BRAM 1102 data. Now, it is desirable to filter out oddly shaped “boxes” by comparing Xsize (Xmax−Xmin) versus Ysize (Ymax−Ymin). If Xsize/Ysize or Ysize/Xsize <=30% (or any other predetermined value), then those boxes are invalidated. In addition to that, it is desirable to find boxes that are filled with blobs of pixels, thereby covering a good area of the found box. Therefore, the system also filters by checking to see (pixel count)/Xsize×Ysize <=30% (or any other predetermined value), setting these locations as invalid. If the data has passed all of the filters, then it is marked as a valid rank and passed along to the Ranking section. Only those that were valid will be Ranked and saved locally for additional modules. Because of the delays in ranking, State 7 could possibly finish 8 clock cycles after the last read of valid data from BRAM 1102. Therefore, for example, the process waits 8 clock cycles before concluding that the Bounding Box is finished and is currently saved. Since the ranking is done partly in another module, the values are reset which is done from the State 0 to State 1 transition.

As shown in FIG. 16, ranking is done in State 7 and in additional rank modules 1600. The valid bram read 1508 and bounding box data 1102 are filtered 1604 to identify a valid rank. Additionally, the result read and valid rank have a one clock delay added 1606 1608. If the data is found to be a valid rank 1602 then that is further ranked by the rank modules 1600.

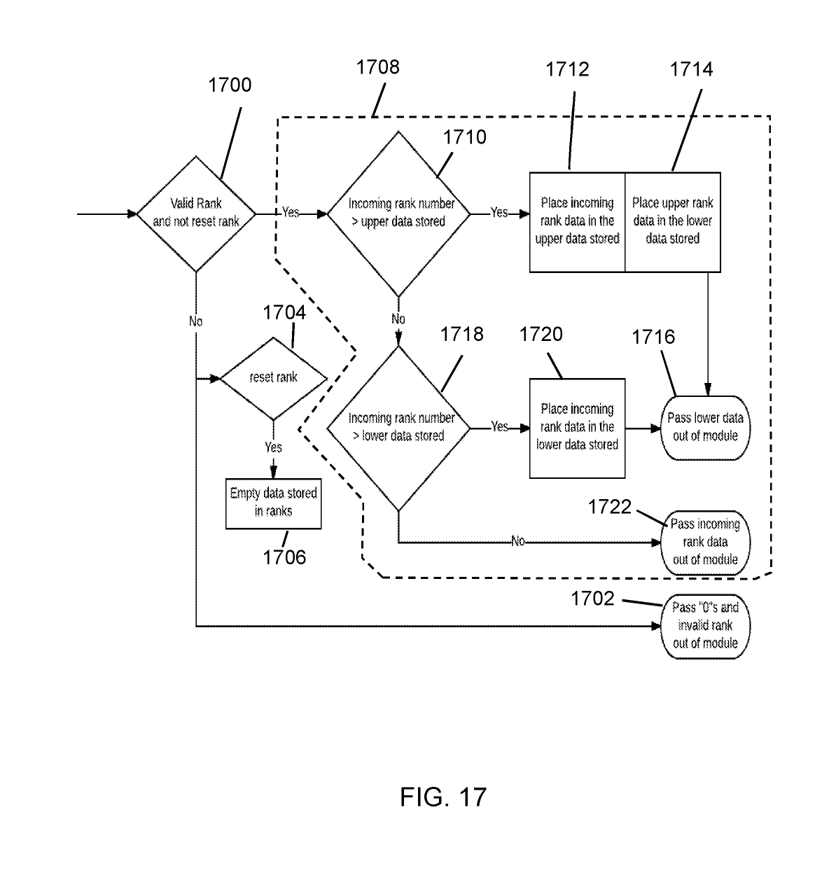

For further understanding, FIG. 17 depicts a flowchart of State 7, focusing on the ranked operation in each of the individual rank modules. Each rank module first starts by determining 1700 if the rank associated with the bounding box or region is valid or if a reset rank has been issued. If the rank is an invalid rank, determined by valid rank value of 0, then the module will send out pass along invalid rank command and “0”s values for associated data. If the rank is a reset rank 1704, then the system empties data 1706 stored in the ranks. Emptying data 1706 stored in ranks refers to the locally stored ranked data. This ranked data will later hold values found from the Recall BRAM reads ultimately locally storing pixel count, xmax, xmin, ymax, ymin and the max between (Xsize=xmax-xmin vs Ysize=ymax-ymin). The rank modules each create a rank number by dividing the pixel count by the maximum between the Xsize and Ysize. That rank number and valid rank transfers 1708 between the rank modules such that the highest rank numbers stay at the top with the lower ranked numbers bumped down to open ranks or out of the saved area entirely. This process proceeds by first determining 1710 if the incoming rank is greater than the upper rank of currently stored data. If so, the incoming rank is then set 1712 as the upper rank of currently stored data, with the previously stored upper rank data then being set 1714 as the lower data stored and removed 1716 from the rank module. If the incoming rank is less than the upper rank of currently stored data, then it is determined 1718 if the incoming rank is greater than the lower rank of the previously stored data. If not, then the incoming ranked data is removed 1722 from the rank module. Alternatively, if the incoming rank is greater than the lower rank of the previously stored data, then the incoming rank data is set 1720 as the lower ranked stored data and passed out of the rank module 1716.

(3.3.3) Hardware Implementation Results

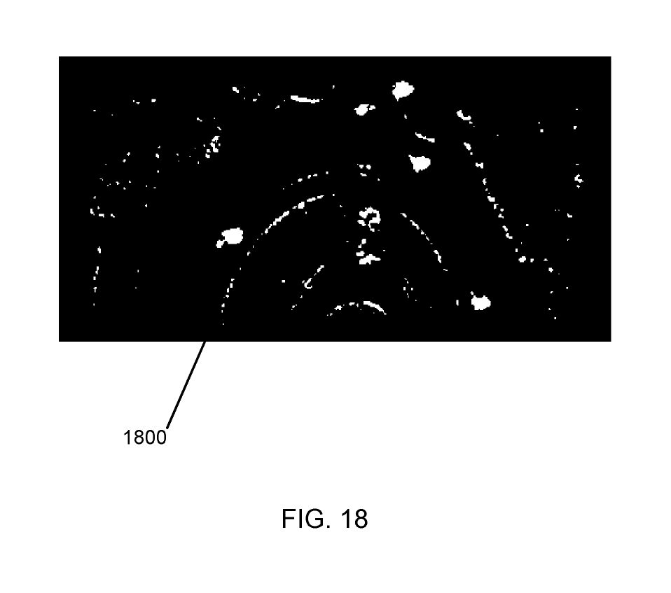

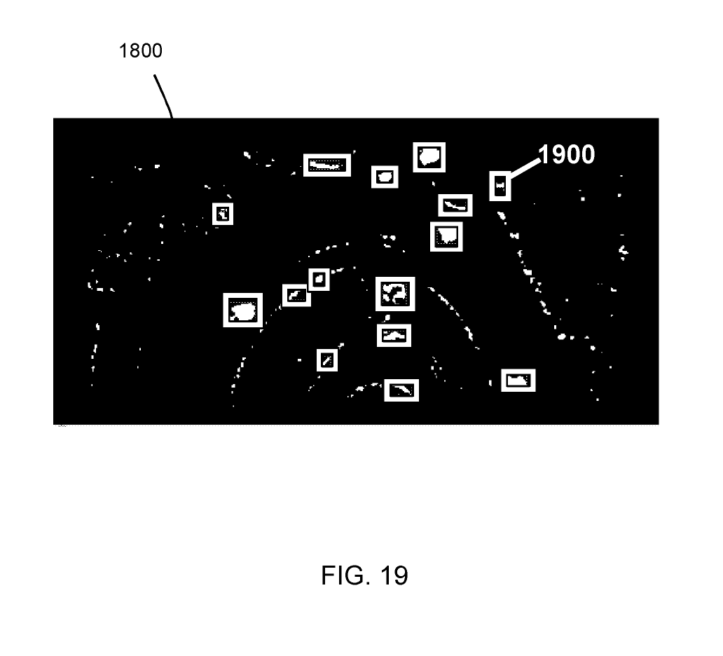

Simulations were conducted in which a known image was passed through the Bound Box Implementation described above. Adhering to the algorithm needs and as shown in FIG. 18, the known image 1800 was 512×256 pixels in size, with single bit pixels (i.e., one-bit value for each pixel location). Passing the image 1800 through the filter, the system identified 220 labeled locations, which are later merged into 182 unique Bounding Boxes. Through ranking, the system filtered the bounding boxes down to the top 15 “ranked” locations (as shown FIG. 19). Thus, it was shown that the Bounding Box process of the present disclosure was effective in identified objects in the image and generating a bounding box around such an object. Based on that, the Bounding Box process described herein can be implemented on consecutive frames in a video image to operate as an efficient and effective movement tracker in any desired setting.

(3.4) Control of a Device.

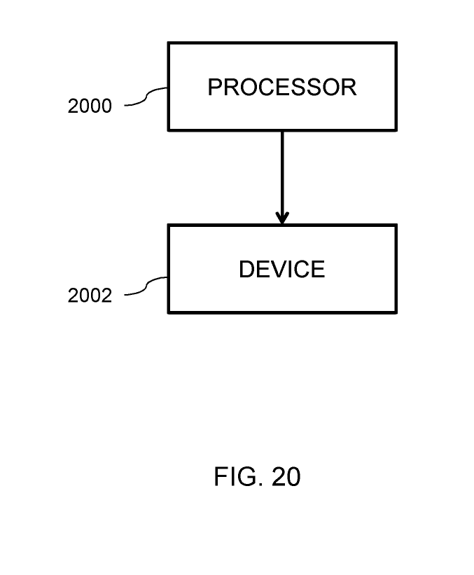

As shown in FIG. 20, a processor 2000 may be used to control a device 2002 (e.g., a mobile device display, a virtual reality display, an augmented reality display, a computer monitor, a motor, a machine, a drone, a camera, etc.) based on the bounding box generation. The control of the device 2002 may be used to transform the localization of an object into a still image or video representing the object. In other embodiments, the device 2002 may be controlled to cause the device to move or otherwise initiate a physical action based on the discrimination and localization.

In some embodiments, a drone or other autonomous vehicle may be controlled to move to an area where the localization of the object is determined to be based on the imagery. In yet some other embodiments, a camera may be controlled to track an identified object by maintaining a moving bounding box within a field of view. In other words, actuators or motors are activated to cause the camera (or sensor) to move to maintain the bounding box within the field of view so that an operator or other system can identify and track the object. As yet another example, the device can be an autonomous vehicle, such as an unmanned aerial vehicle (UAV), that includes a camera and the bounding box design described herein. In operation and when a bounding box is generated by the system as implemented in the UAV, the UAV can be caused to maneuver to follow the object such that the bounding box remains within the field of view of the UAV. For example, rotors and other components of the UAV are actuated to cause the UAV to track and following the object.

Finally, while this invention has been described in terms of several embodiments, one of ordinary skill in the art will readily recognize that the invention may have other applications in other environments. It should be noted that many embodiments and implementations are possible. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A system for bounding box generation, the system comprising:
one or more processors and a memory, the memory having executable instructions, such that upon execution of the instructions, the one or more processors perform operations of:
receiving an image, the image comprised of pixels having a one-bit value per pixel;
generating bounding boxes around connected components in the image, the connected components having pixel coordinate and pixel count information;
generating a ranking score for each bounding box based on the pixel coordinate and pixel count information;
filtering the bounding boxes to remove bounding boxes that exceed a predetermined size and pixel count based on the pixel coordinate and pixel count information; and
filtering the bounding boxes to remove bounding boxes that fall below a predetermined ranking score, resulting in remaining bounding boxes; and
controlling a device based on the remaining bounding boxes.

2. The system as set forth in claim 1, wherein the processor is a field programmable gate array (FPGA).

3. The system as set forth in claim 1, wherein generating the bounding box further includes operations of:
grouping contiguous pixels in the image; and
merging connected pixels as connected components, with the bounding box formed of a box that encompasses the connected components.

4. The system as set forth in claim 1, wherein controlling the device includes causing a video platform to move to maintain at least one of the remaining bounding boxes within a field of view of the video platform.

5. A computer program product for bounding box generation, the computer program product comprising:
a non-transitory computer-readable medium having executable instructions encoded thereon, such that upon execution of the instructions by one or more processors, the one or more processors perform operations of:
receiving an image, the image comprised of pixels having a one-bit value per pixel;
generating bounding boxes around connected components in the image, the connected components having pixel coordinate and pixel count information;
generating a ranking score for each bounding box based on the pixel coordinate and pixel count information;
filtering the bounding boxes to remove bounding boxes that exceed a predetermined size and pixel count based on the pixel coordinate and pixel count information; and
filtering the bounding boxes to remove bounding boxes that fall below a predetermined ranking score, resulting in remaining bounding boxes; and
controlling a device based on the remaining bounding boxes.

6. The computer program product as set forth in claim 5, wherein the processor is a field programmable gate array (FPGA).

7. The computer program product as set forth in claim 5, wherein generating the bounding box further includes operations of:
grouping contiguous pixels in the image; and
merging connected pixels as connected components, with the bounding box formed of a box that encompasses the connected components.

8. The computer program product as set forth in claim 5, wherein controlling the device includes causing a video platform to move to maintain at least one of the remaining bounding boxes within a field of view of the video platform.

9. A computer implemented method for bounding box generation, the method comprising an act of:
causing one or more processors to execute instructions encoded on a non-transitory computer-readable medium, such that upon execution, the one or more processors perform operations of:
receiving an image, the image comprised of pixels having a one-bit value per pixel;
generating bounding boxes around connected components in the image, the connected components having pixel coordinate and pixel count information;
generating a ranking score for each bounding box based on the pixel coordinate and pixel count information;
filtering the bounding boxes to remove bounding boxes that exceed a predetermined size and pixel count based on the pixel coordinate and pixel count information; and
filtering the bounding boxes to remove bounding boxes that fall below a predetermined ranking score, resulting in remaining bounding boxes; and
controlling a device based on the remaining bounding boxes.

10. The method as set forth in claim 9, wherein the processor is a field programmable gate array (FPGA).

11. The method as set forth in claim 9, wherein generating the bounding box further includes operations of:
grouping contiguous pixels in the image; and
merging connected pixels as connected components, with the bounding box formed of a box that encompasses the connected components.

12. The method as set forth in claim 9, wherein controlling the device includes causing a video platform to move to maintain at least one of the remaining bounding boxes within a field of view of the video platform.
